(19) United States
(12) Patent Application Publication
(10) Pub. No.: US 2003/0064197 A1
(43) Pub. Date: Apr. 3, 2003

(54) Decorative lining for a pool

(76) Inventor: James Kindley, Dallas, TX (US)

Correspondence Address: CARR LAW FIRM, L.L.P., 670 FOUNDERS SQUARE, 900 JACKSON STREET, DALLAS, TX, 75202, US

(21) Appl. No.: 10/287,309

(22) Filed: Nov. 4, 2002

Related U.S. Application Data
(63) Continuation-in-part of application No. 09/923,003, filed on Aug. 3, 2001.

(51) Int. Cl. B29C 33/40; B32B 3/00

(52) U.S. Cl. 428/156; 264/129; 264/219

(57) ABSTRACT

A decorative liner for a pool assembly including a liner configured for being positioned in a pool, pond, or fountain, one or more display surfaces on the liner, and one or more distinct raised portions formed in the shape of one or more tiles on the one or more display surfaces.

This application is a continuation-in-part of pending application Ser. No. 09/923,003, filed Aug. 3, 2001.

### BACKGROUND

Many swimming pools, water fountains, tubs, and artificial ponds (collectively referred to herein as “pools”) have sections of floor or wall covered by decorative mosaic tiles. One method of installing such mosaic tiles is to assemble small pieces of glazed-ceramic tile of different colors to form an aesthetically pleasing pattern or a picture. This process requires each tile piece to be separately placed and fastened by hand.

There are a number of drawbacks with using this method of decoration. First, it is a time-consuming process and is relatively expensive. Additionally, the method generally requires a skilled artisan to travel to the location of the object to be tiled, since the object is often too large or too heavy to be easily moved to the artisan's location. Furthermore, the fact that the mosaic design is made of many individual pieces means that the pieces need to be mounted to a hard, stable surface to resist falling apart. Typically, the mounting surface that is chosen is the pool bottom, and, as a result, the mounted mosaic becomes a permanent part of the pool and cannot be removed for cleaning, replacement, or pool maintenance.

Therefore, what is needed is a method and apparatus for decorating a pool without incurring the time, expense, and travel associated with applying traditional mosaic-tile decoration.

### SUMMARY

The present invention achieves these and other objectives using a decorative liner for a pool assembly comprising a liner configured for being positioned in one of a pool, pond, or fountain, one or more display surfaces on the liner, and one or more distinct raised portions formed in the shape of one or more tiles on the one or more display surfaces.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of an embodiment of the invention in a circular, aboveground fountain embodying features of the present invention;

FIG. 2 is a cross-section of the fountain assembly of FIG. 1 taken along line 2-2 of FIG. 1;

FIG. 3 is a top view of a decorative liner embodying features of the present invention;

FIG. 4 is an enlarged view of the portion of the decorative liner of FIG. 3 circumscribed by the line 4 of FIG. 3;

FIG. 5 is a cross-section of a portion of the decorative liner shown in FIG. 4, taken along line 5-5 of FIG. 4;

FIG. 6 is a cross-section of a decorative liner that is decorated on both sides;

FIG. 7 is a perspective view of an in-ground fountain having a decorative liner embodying features of the present invention;

FIG. 8 is a cross-section of the pool of FIG. 7 taken along line 8-8 of FIG. 7;

FIG. 9 is a top view of the in-ground pool without decorative liner; and

FIG. 10 is a flow-chart depicting steps that may be performed in fabricating the decorative liner of the present invention.

### DETAILED DESCRIPTION

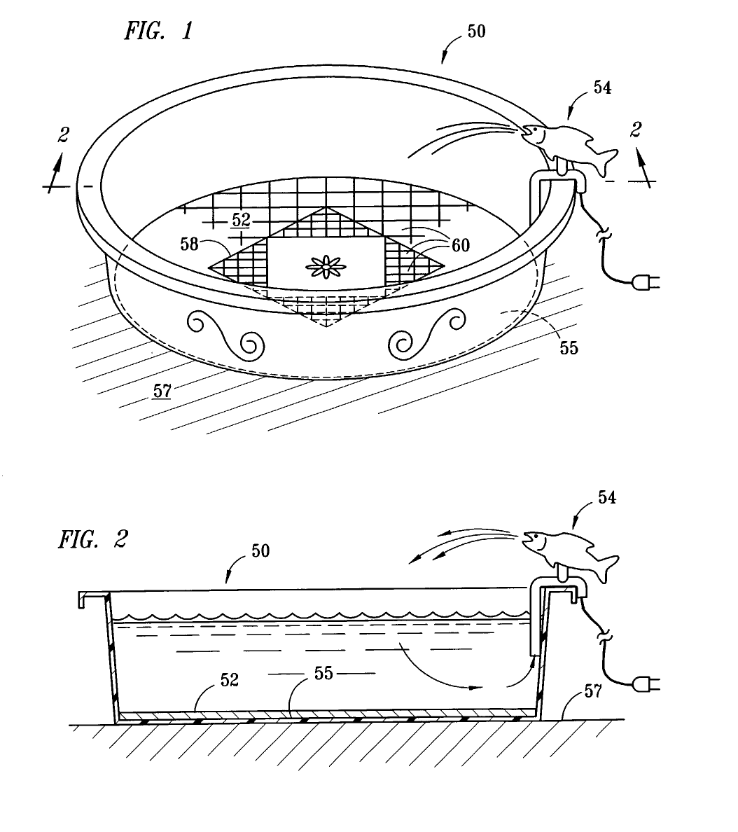

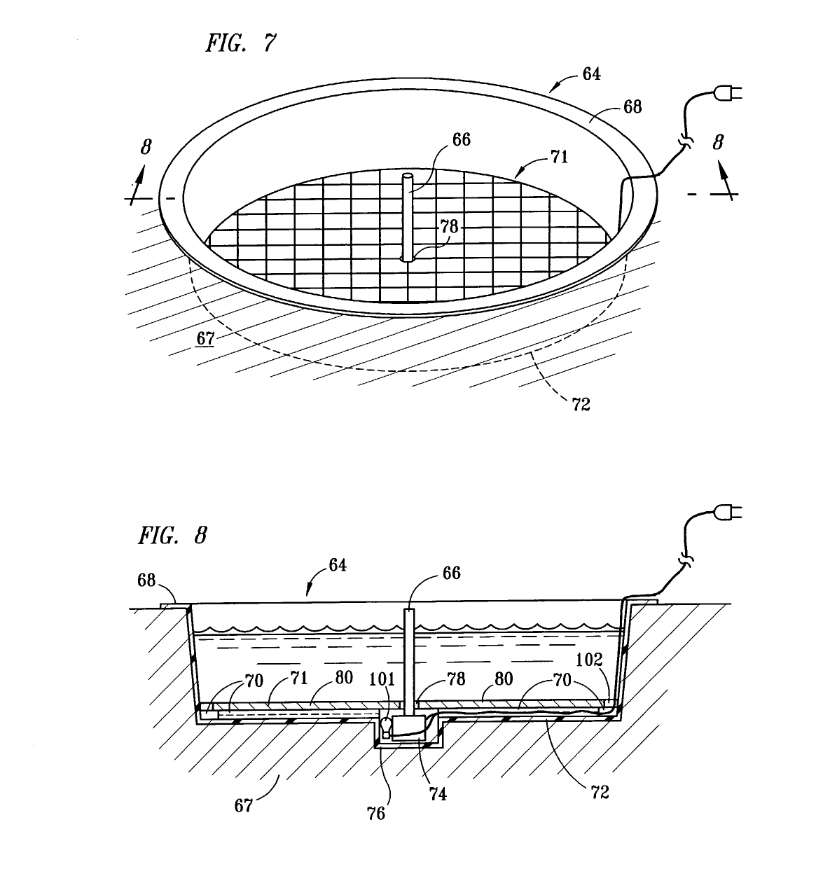

Referring to FIG. 1 of the drawings, the reference numeral 50 generally designates an above-ground swimming pool, water fountain, artificial pond, or the like (collectively referred to hereinafter as a “pool” or a “basin”) having a decorative liner 52 embodying features of the present invention. A pump assembly 54 comprising a pump (not shown) and fountain nozzle (not shown) is located on the side of the pool 50 in this embodiment, but, optionally, may be excluded from the pool. As depicted in FIG. 1, the pool 50 is preferably positioned on the ground 57 in this embodiment, though it may also be sunken into the ground 57, as discussed below with reference to FIG. 7. In the embodiment of FIG. 1, the decorative liner 52 is positioned directly on a floor 55 of the pool 50, as shown in the cross-section of FIG. 2. The decorative liner 52 is preferably not fastened to the pool 50, so that the liner 52 may be removed more easily. However, the liner 52 may be fastened to the pool 50 if desired.

The pool 50 is preferably fabricated from polyurethane, though any materials may be used which are effective for containing water and are weather resistant, such as most plastics, concrete, and the like. The pool 50 is preferably manufactured using a form-fill process that is well known in the manufacturing field, though the pool may be manufactured using other techniques, such as a vacuum-form process, and the like.

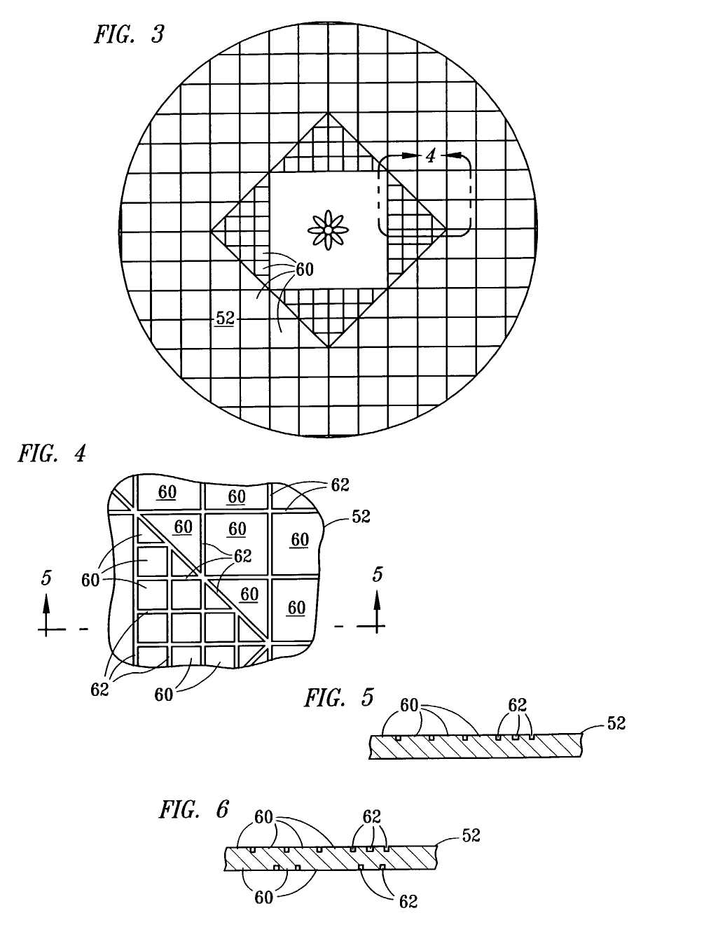

FIG. 3 depicts a top view of one embodiment of the decorative liner 52. This view shows a mosaic design 58 created on the display surface of the liner 52 by arrangement of raised tile portions 60. It is understood that the present invention is not limited to any particular mosaic design and that the mosaic design shown in FIG. 3 is shown only by way of example. FIG. 4 show an expanded view of the same decorative liner 52, more clearly depicting the positioning of the raised tile portions 60 with respect to one another. The tile portions 60 are preferably colored a variety of colors by being painted, though they may also be colored by other coloring methods such as using dies in the material used for fabrication of the liner, or may be left unpainted. The tile portions 60 and are preferably separated from one another by recessed “grout” areas 62 molded into the liner 52. The liner 52 is preferably colored to resemble grout, and the grout areas 62 are preferably not painted, though they may be painted if desired. FIG. 5 is a cross-section of FIG. 4, which more clearly depicts the distinction between grout portions 62 and tile portions 60. FIG. 6 is a cross-section of FIG. 4, which shows how the decorative liner 52 may be molded with a different mosaic design (not shown) on each side of the liner 52, thereby permitting the liner 52 to be periodically flipped over as desired for variety.

FIGS. 7-9 depict an alternate embodiment of the present invention in which the decorative liner 71 is positioned in an in-ground pool 64. The liner optionally defines a centrally positioned hole 78 through which a fountain stem 66 may be extended. As more clearly depicted in FIG. 8, the pool 64 is preferably sunken into the ground 67 up to a top rim 68, but may be sunken into the ground 67 to any degree. A pump 74 is preferably located in a recessed area 76 molded into the pool floor 72, as shown in FIG. 8. Also, an underwater light 101 is also preferably located in a recessed area below the liner 71, preferably either recessed area 76 or one of the channels 70. The liner 71 is preferably configured to conceal the pump 74. The pump 74 is connected directly to the fountain stem 66, which extends upwardly through a hole 78 defined in the center of the decorative liner 71, as shown in FIG. 8. Alternatively, the liner may be used to decorate a pool without including a pump and fountain stem.

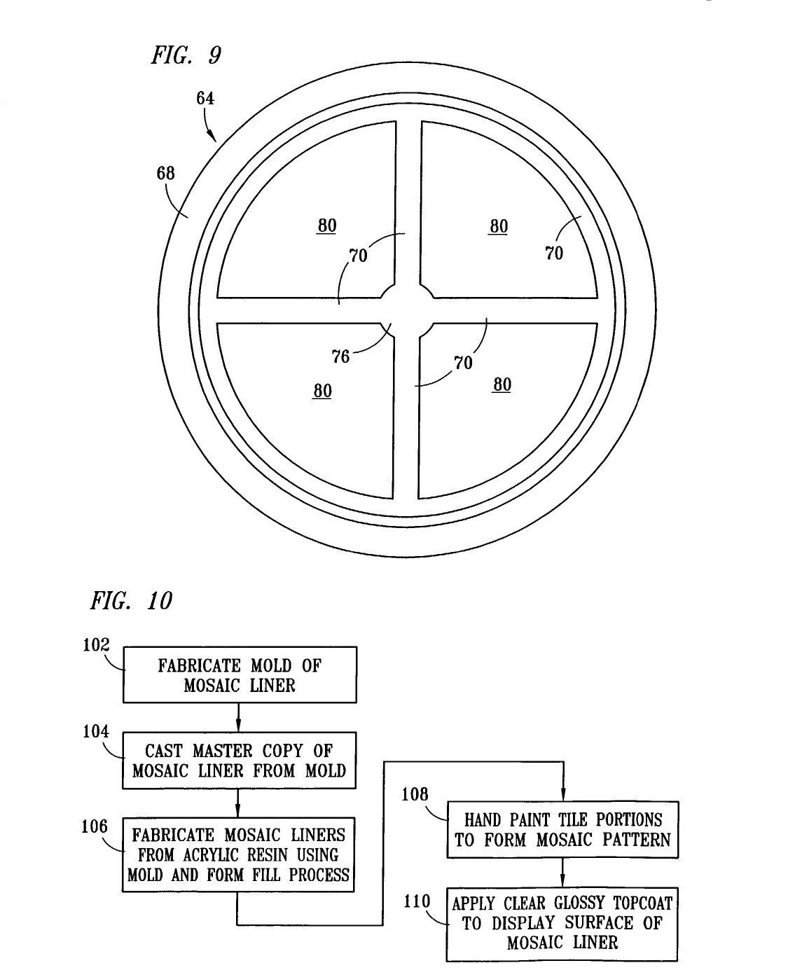

As most clearly shown in FIG. 9, recessed channels 70 are preferably molded into a floor 72 of the pool, thereby forming “pie-shape” sections 80, on which the decorative liner 71 preferably rests. The channels 70 are preferably configured to allow water to flow under the decorative liner 71 to the pump 74. The channels 70 also provide increased strength in the pool 64 during transit. In addition, the channels 70 also improve passage of light from underwater light 101 to the periphery of the liner 71. Alternatively, water flow to the pump may be achieved by using a hose (not shown), or by positioning the liner 71 on some form of stand (not shown) having the effect of supporting the liner 71 off of the pool floor 72. It is also possible to use a side-mounted pump assembly 54 as shown in FIG. 1, in which case water flow under the liner 71 is unnecessary. The decorative liner 71 of FIG. 7 is substantially the same as the decorative liner 52 of FIG. 3 except for the hole 78 defined in its center.

Although the periphery of the liner 71 closely matches the floor 72 of the pool, 102 remains around all or most of the periphery of the liner 71 to permit the escape of light from underwater light 101, which results in a subtle and pleasant glow emanating from the periphery of the liner as seen from above.

In the embodiment shown in FIG. 7, the pool 64 is preferably fabricated from polyethylene using a vacuum-form process, though any material may be used which is effective for containing water and is weather resistant, such as most plastics, concrete, and the like, and the pool 64 may be constructed using other manufacturing processes, such as a form-fill process.

FIG. 10 is a flow chart depicting steps that may be performed to fabricate a decorative liner 52 in accordance with the present invention. In step 102, a mold (not shown) of a decorative liner is fabricated. To fabricate the mold, the mosaic tile pattern 58 is preferably sculpted by hand into a sheet of clay (not shown). This may be done using a tile mosaic made with real tile (not shown), or a picture of such a mosaic, as a model. Alternatively, the mold may be cast directly from a real-tile mosaic (not shown). The mold is then cast from the clay sculpture or the tile mosaic preferably by covering the clay sculpture or real tile mosaic with a thermosetting or heat-cured material, and then curing the material; though other methods may be used for fabricating the mold that are effective for capturing and retaining the mosaic design. The mold in step 102 is preferably fabricated from a semi-rigid material such as silicon, rubber, or gum, although any material may be used which is effective for retaining the shape of the mosaic pattern and transferring the pattern to a liner.

In step 104, a plastic “master” (not shown, but similar to 52) is preferably cast from the mold. The master is preferably cast from the same material and using the same process as is used in step 106 (described below) for making the decorative liners 52, though other materials may be used which are effective for retaining the shape of the mosaic design. The mold of step 102 will generally wear out after several hundred liners 52 have been cast from it. Additional molds are preferably cast from the master, as the original clay sculpture of step 102 is generally destroyed in the process of making the first mold.

In step 106, decorative liners 52 are fabricated from the mold cast in step 102, preferably from acrylic resin using a form-fill process. Alternatively, liners may be cast from any materials which are effective for being cast and for holding the shape of the mosaic design, such as metals, plastics, plaster, and the like, and other manufacturing processes may be used, such as a vacuum-form process. The decorative liners 52 are preferably fabricated as a solid sheet. The acrylic resin (not shown) or other material used to construct the liners 52 is preferably pre-dyed a color desirable for the grout portions 62, so that the grout portions 62 do not need to be painted after the liner 52 is cast.

In step 108, after the decorative liner 52 is formed, the tile portions 60 of the decorative liner 52 are preferably hand-painted in the appropriate colors to form a mosaic design 58. Alternatively, the tile portions 60 may be painted using automated machinery (not shown). The paint is preferably acrylic paint, although any paint may be used that is water-resistant, such as most oil-based paints, or any other paint if the liner 52 will not be used underwater or if the liner is coated with a topcoat. The grout portions 62 are preferably not painted.

In step 110 a clear, water-resistant, glossy topcoat is optionally applied to give the tile portions 60 the glossy appearance of glazed-ceramic tile. The topcoat is preferably acrylic, although any coating may be used that is water-resistant, such as lacquer, enamel, polyurethane, and the like, or any other coating if the liner 52 will not be used underwater. Alternatively, the tile portions 60 may be painted with a glossy paint in step 108 in lieu of applying a separate glossy coat in step 110, or the tiles may be left without a glossy finish.

The present invention has several advantages over the prior art method of decorating with individual tiles. For example, the “tiles” do not need to be individually laid because they are molded from a single solid sheet. This saves a significant amount of time. Although the tile portions 60 must be painted, the painting can be accomplished more cheaply than laying individual tiles because the work does not require a skilled artisan, and the painting may be done in a factory setting instead of requiring an artisan to travel to the pool site.

Another advantage is that, unlike individual tiles, the decorative liner 52 does not need to be permanently mounted to another surface to stay together. This eliminates the need to fasten the decoration permanently to a pool. Therefore, the decorative liner 52 may be removed easily for cleaning, replacement, or maintenance. Another advantage of the ability to install a decorative liner 52 without permanently attaching it to a pool is that a water pump for a fountain may be housed inside the pool, under the decorative liner. This is not feasible with traditional mosaic arrangements, because placing tile over the pump would restrict access to the pump for service or replacement.

Another advantage is the ease of cleaning the mosaic decoration. The grout in traditional tile mosaics tends to become discolored over time. This discoloration is difficult to clean and may require that the pool be emptied before it can be cleaned. In the present invention, however, the “grout” is made of the same plastic as the tiles, and it may be easily cleaned. The decorative liner may be removed for cleaning outside the pool without draining the pool. It is understood that the present invention may take many other forms and embodiments. Accordingly, several variations may be made in the foregoing without departing from the spirit or the scope of the invention. For example, the decorative liner 52 may be used to decorate objects other than pools or fountains, such as floors, countertops, shower walls, and decorative accessories, as well as tables or other furniture. The decorative liner 52 may even be displayed alone as artwork. The method of this invention may be used to recreate famous mosaic-tile masterpieces.

The pools 50, 64 and decorative liners 52, 71 in the fountain assemblies depicted in FIGS. 1 and 7 may be made in other shapes, such as rectangular. Decorative sections embodying features of the present invention may be used to decorate the inside or outside walls or the top rim of a pool. The decorative liner 52 may be used in a fishpond or an aquarium. Additionally, some of the advantages of using the decorative liner 52 may be realized if the liner 52 is attractively decorated, even if the surface is not molded into tile shapes. Alternatively, other advantages of the present invention may be realized if the decorative liner 52 is molded as part of the pool 50, i.e. the tile design is molded into the plastic of the bottom, top, or sides of the pool.

Having thus described the present invention by reference to certain of its preferred embodiments, it is noted that the embodiments disclosed are illustrative rather than limiting in nature, and that a wide range of variations, modifications, changes, and substitutions are contemplated in the foregoing disclosure and, in some instances, some features of the present invention may be employed without a corresponding use of the other features. Many such variations and modifications of the present invention may be considered obvious and desirable by those skilled in the art based upon a review of the foregoing description of preferred embodiments. Accordingly, it is appropriate that the appended claims be construed broadly, and in a manner consistent with the scope of the invention.

1. A decorative liner for a pool assembly comprising:
a liner configured for being positioned in a pool;
one or more display surfaces on the liner; and
one or more distinct raised portions formed in the shape of one or more tiles on the one or more display surfaces.

2. The decorative liner of claim 1 wherein the liner is configured for being positioned on at least one of a floor of a pool, an interior wall of a pool, an exterior wall of a pool, or a rim of a pool.

3. The decorative liner of claim 1 wherein the decorative liner is configured to conceal a recessed region in a floor of a pool, and wherein the recessed region in a floor of a pool is configured to house a pump.

4. The decorative liner of claim 1, wherein the liner is fabricated from a polymer.

5. The decorative liner of claim 1, wherein the one or more distinct raised portions of the display surface are colored to resemble one or more tiles.

6. The decorative liner of claim 1, wherein:
the one or more distinct raised portions of the display surface are colored to resemble one or more tiles; and
two or more of the one or more distinct raised portions are arranged to form a mosaic design.

7. The decorative liner of claim 1, wherein:
the one or more distinct raised portions of the display surface are colored to resemble one or more tiles;
two or more of the one or more distinct raised portions are arranged to form a mosaic design; and
the display surface is coated with a topcoat.

8. The decorative liner of claim 7, wherein the liner is fabricated from a polymer.

9. The decorative liner of claim 1 wherein the display surface is coated with a topcoat.

10. The decorative liner of claim 9 wherein the topcoat comprises a polymer.

11. The decorative liner of claim 1 further comprising a pool configured for containing liquids, the pool being configured so that the liner may be positioned in the pool.

12. The decorative liner of claim 11 further comprising a recessed region in the floor of the pool, the recessed region being configured to house a pump, and wherein the liner is configured to conceal the recessed area.

13. The decorative liner of claim 1 wherein the decorative liner is configured to conceal a recessed region in a floor of a pool, and wherein the recessed region in a floor of a pool is configured to retain an underwater light.

14. A decorative liner comprising:
a liner having:
one or more display surfaces; and
one or more distinct raised portions formed in the shape of one or more tiles on the one or more display surfaces; and
a topcoat applied over the one or more distinct raised portions on the liner; the topcoat comprising a polymer.

15. The decorative liner of claim 13, wherein the topcoat comprises one of an acrylic enamel, lacquer, or polyurethane.

16. The decorative liner of claim 13, wherein the liner is fabricated from a polymer.

17. The decorative liner of claim 13, wherein the one or more distinct raised portions are colored to resemble one or more tiles.

18. The decorative liner of claim 13, wherein:
the one or more distinct raised portions of the display surface are colored to resemble one or more tiles; and
two or more of the one or more distinct raised portions are arranged to form a mosaic design.

19. The decorative liner of claim 17, wherein the liner is configured to be positioned in a pool.

20. A pool assembly comprising:
a basin configured for containing liquids; and
a removable decorative liner positioned in the basin, the removable decorative liner being configured to cover a portion of the floor of the basin.

21. The pool assembly of claim 19 further comprising a recessed region in a floor of the basin, the recessed region being configured to retain a pump.

22. The pool assembly of claim 20 wherein the removable decorative liner is configured to conceal the recessed region in a floor of the basin, and further comprising a hole defined in the removable decorative liner, the hole being defined so that a fountain stem may be extended from a pump upwards through the removable decorative liner.

23. The pool assembly of claim 19 further comprising a recessed region in a floor of the basin, the recessed region being configured to hold an underwater light.

24. A method for producing a decorative liner comprising the steps of:
fabricating a mold by:
covering a mosaic arrangement with a thermosetting or heat-cured material; and
curing the thermosetting or heat-cured material;
and
casting a decorative liner from the mold.

25. The method of claim 22 for producing a decorative liner wherein the mosaic arrangement is one of a mosaic tile arrangement made from real tiles or a sculpture resembling a mosaic tile arrangement made from real tiles.

26. A method for producing a decorative liner comprising the steps of:
casting a decorative liner, the decorative liner having one or more distinct raised portions formed in the shape of tiles; and
coating the one or more distinct raised portions with a topcoat, the topcoat comprising a polymer.

27. The method of claim 24 for producing a decorative liner further comprising the step of coloring the one or more distinct raised portions before applying the topcoat.

28. The method of claim 24 for producing a decorative liner wherein the decorative liner is fabricated from a polymer.

29. The method of claim 24 for producing a decorative liner wherein the decorative liner is fabricated from a polymer, and further comprising the step of coloring the one or more distinct raised portions before applying the topcoat.

30. A pool assembly comprising:
a basin configured for containing liquids; and
a decorative liner positioned in the basin, the decorative liner having:
one or more display surfaces;
one or more distinct raised portions formed in the shape of one or more tiles on the one or more display surfaces, the one or more tiles being arranged to form a mosaic design; and
a topcoat comprising a polymer applied to the display surface.
